(19) United States
(12) Patent Application Publication
(10) Pub. No.: US 2015/0156600 A1
(43) Pub. Date: Jun. 4, 2015

(54) METHOD AND ELECTRONIC DEVICE

(71) Applicant: KABUSHIKI KAISHA TOSHIBA, Tokyo (JP)

(72) Inventor: Toshifumi YAMAMOTO, Tokyo (JP)

(21) Appl. No.: 14/445,594

(22) Filed: Jul. 29, 2014

(30) Foreign Application Priority Data
Nov. 29, 2013 (JP) 2013-247708

(51) Int. Cl. H04S 7/00; H04R 5/02

(52) U.S. Cl. CPC H04S 7/302; H04R 5/02

(57) ABSTRACT

According to one embodiment, a method of reproducing sound from an electronic device includes delaying a first phase of a first sound with respect to a phase of an input signal, and advancing a second phase of a second sound with respect to the phase of the input signal. The first sound is configured to be output from a first speaker of a plurality of speakers arranged adjacent to each other. The first speaker is at a first position. The second sound is configured to be output from a second speaker out of the plurality speakers. The second speaker is at a second position. A distance between the first position and a user is smaller than a distance between the second position and the user.

### CROSS-REFERENCE TO RELATED APPLICATIONS

This application is based upon and claims the benefit of priority from. Japanese Patent Application No. 2013-247708, filed Nov. 29, 2013, the entire contents of which are incorporated herein by reference.

### FIELD

Embodiments described herein relate generally to a method and an electronic device.

### BACKGROUND

Conventionally, there has been known a configuration of an in-vehicle audio system or the like, which comprises a plurality of speakers arranged adjacent to each other in a room. In such a configuration, sounds output from the speakers resonate and interfere with each other in the room, thereby acoustic effects at a position of a listener can be impaired. Accordingly, in order to improve the acoustic effects at the position of the listener, there has been proposed a technique that provides directivity to the sounds output from the all speakers so that the sounds are output in the direction toward the position of the listener by processing of filtering accompanied with complicate calculations in consideration of acoustic characteristics and the like of the respective speakers.

In the technique described above, as one example, it is preferable to improve the acoustic effects at the position of the listener by an easier method.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram illustrating a vehicle provided with a speaker device according to an embodiment;

FIG. 2 is an exemplary schematic diagram illustrating a physical relationship between the speaker device and a listener (an occupant) in the embodiment;

FIG. 3 is an exemplary block diagram illustrating an internal configuration of the speaker device in the embodiment;

FIGS. 4A to 4C are exemplary diagrams illustrating variations in sound pressure of sounds output from the speaker device at three different positions in the embodiment;

FIGS. 5A and 5B are exemplary diagrams illustrating filter coefficients used for two FIR filters comprised in the speaker device in the embodiment;

FIG. 6 is an exemplary diagram illustrating advantageous effects in the embodiment;

FIGS. 7A and 7B are exemplary diagrams illustrating filter coefficients used for two FIR filters comprised in a speaker device according to a first modification;

FIG. 8 is an exemplary block diagram illustrating an internal configuration of a speaker device according to a second modification;

FIGS. 9A and 9B are exemplary diagrams illustrating filter coefficients used for two FIR filters comprised in the speaker device in the second modification; and

FIG. 10 is an exemplary block diagram illustrating an internal configuration of a speaker device according to a third modification.

### DETAILED DESCRIPTION

In general, according to one embodiment, a method of reproducing sound from an electronic device comprises delaying a first phase of a first sound with respect to a phase of an input signal, and advancing a second phase of a second sound with respect to the phase of the input signal. The first sound is configured to be output from a first speaker of a plurality of speakers arranged adjacent to each other. The first speaker is at a first position. The second sound is configured to be output from a second speaker out of the plurality speakers. The second speaker is at a second position. A distance between the first position and a user is smaller than a distance between the second position and the user.

Hereinafter, an embodiment is explained in conjunction with drawings.

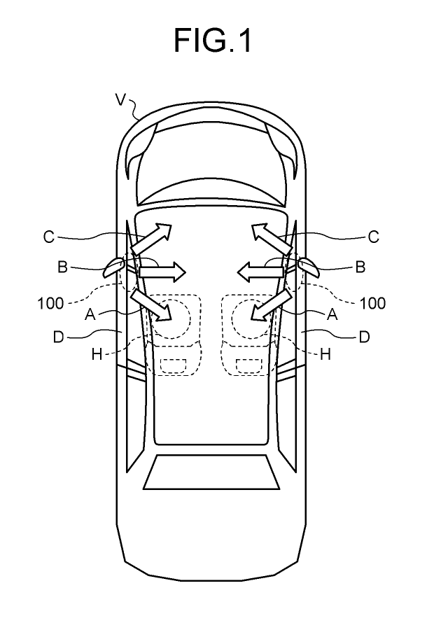

First of all, with reference to FIG. 1 to FIG. 6, the configuration of a speaker device 100 according to the present embodiment is explained. Here, the speaker device 100 is one example of an “electronic device”.

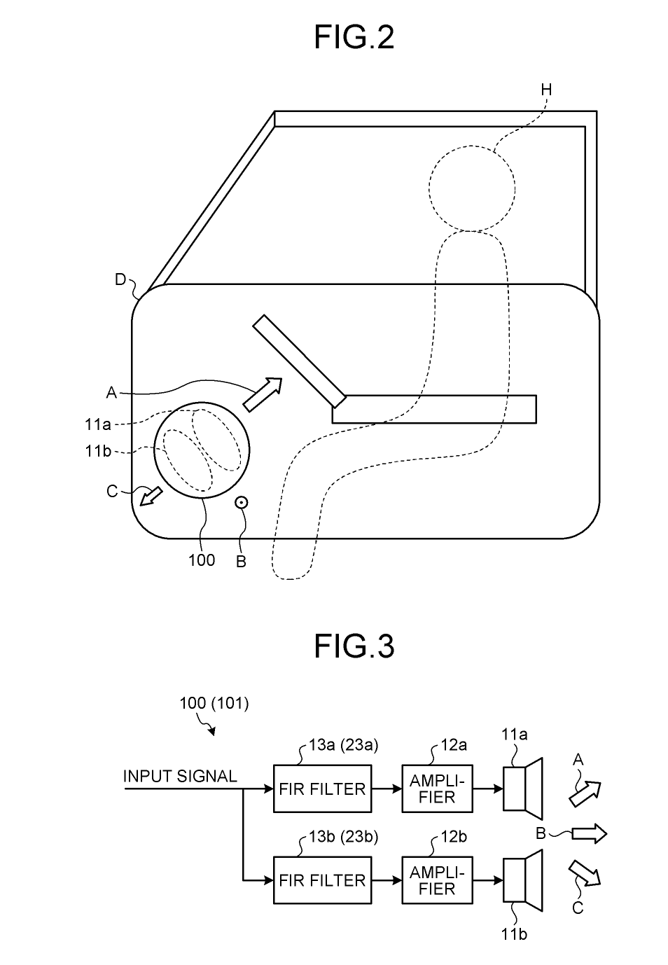

As illustrated in FIG. 1 and FIG. 2, the speaker device 100 is, as one example, provided to each front door D of a vehicle V.

As illustrated in FIG. 2, the speaker device 100 is arranged on the foot side of an occupant H in the vehicle V, the occupant H being a listener who listens sounds from the speaker device 100. The speaker device 100 comprises speakers 11a and 11b that are arranged adjacent to each other. The speaker 11a is arranged at a position close to the occupant H. The speaker 11b is arranged at a position distant from the occupant H. The speakers 11a and 11b are examples of a “first speaker” and a “second speaker”, respectively.

To be more specific, as illustrated in FIG. 3, the speaker device 100 comprises the two speakers 11a and 11b, two amplifiers 12a and 12b, and two finite impulse response (FIR) filters 13a and 13b. The amplifiers 12a and 12b are connected to the speakers 11a and 11b, respectively. The FIR filters 13a and 13b are connected to the amplifiers 12a and 12b, respectively.

Here, in the configuration as above that the speaker device 100 is arranged on the foot side of the occupant H, when no processing is performed on an input signal, sounds output from the speakers 11a and 11b advance toward not the head side of the occupant H (see arrow A) but the front side of the speaker device 100 (see arrow B) and the foot side of the occupant H (see arrow C). Accordingly, reflection and interference of sounds can easily occur caused by interior surfaces and the like on the foot side of the occupant H in a vehicle, thereby deterioration of sound quality can easily occur. Therefore, in the configuration above, it is desired that sounds are advanced toward the head of the occupant H by processing that provides directivity, for example, to the sounds so as to acquire the optimal acoustic environment at a position on the head of the occupant H.

Accordingly, in the present embodiment, in order to acquire the optimal acoustic environment at a position on the head of the occupant H, a phase of a first sound output from the speaker 11a and a phase of a second sound output from the speaker 11b are shifted from each other. To be more specific, the phase of the first sound output from the speaker 11a is delayed by π/4 with respect to an input signal by the FIR filter 13a, and the phase of the second sound output from the speaker 11b is advanced by π/4 with respect to the input signal by the FIR filter 13b. According to these configurations, as explained below, it is possible to improve the acoustic environment at a position on the head of the occupant H. Hereinafter, in order to explain the principle of above, a state of each sound at a frequency at which a phase difference is affected effectively is explained.

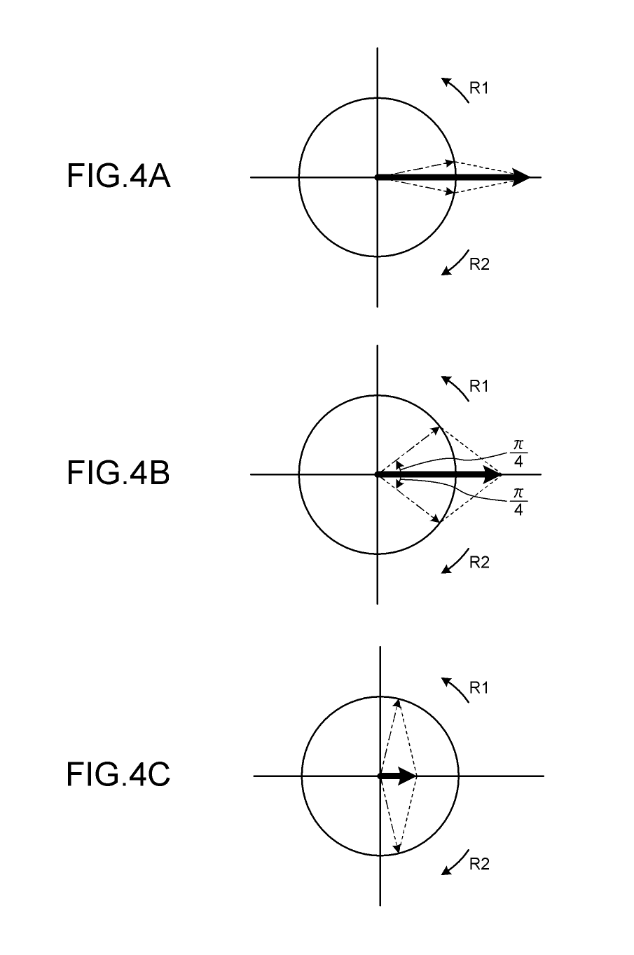

FIGS. 4A to 4C are exemplary diagrams illustrating the sound pressure of a composite tone of the first sound and the second sound in the case where the phase of the first sound and the phase of the second sound are shifted as described above. In FIGS. 4A to 4C, the first sound is indicated by an arrow described by a dashed-dotted line, the second sound is indicated by an arrow described by a chain double-dashed line, and the composite tone is indicated by an arrow described by a thick line. Furthermore, in FIGS. 4A to 4C, the direction of the phase advanced is indicated by an arrow R1 in the counterclockwise direction, and the direction of the phase delayed is indicated by an arrow R2 in the clockwise direction.

FIG. 4A is an exemplary diagram illustrating the sound pressure of a composite tone at a position on the head of the occupant H (see the arrow A in FIG. 1 to FIG. 3). FIG. 4B is an exemplary diagram illustrating the sound pressure of a composite sound at a position on the front side of the speaker 11a and the speaker 11b (see the arrow B in FIG. 1 to FIG. 3). FIG. 4C is an exemplary diagram illustrating the sound pressure of a composite tone at a position on the foot side of the occupant H (see the arrow C in FIG. 1 to FIG. 3).

As illustrated in FIG. 4B, at the position on the front side of the speaker 11a and the speaker 11b (see the arrow B in FIG. 1 to FIG. 3), as the above-mentioned setting, the phase of the first sound is delayed by π/4 with respect to an input signal, and the phase of the second sound is advanced by π/4 with respect to the input signal.

On the other hand, at a position on the head of the occupant H (see the arrow A in FIG. 1 to FIG. 3), a distance relative to the speaker 11a is shorter compared with the above-mentioned case in FIG. 4B and hence, the delay in phase of the first sound is set off in proportion to the decrease of the distance. Therefore, at a position on the head of the occupant H, as illustrated in FIG. 4A, the delay in phase of the first sound becomes smaller than π/4. Furthermore, at a position on the head of the occupant H, a distance relative to the speaker 11b is longer compared with the above-mentioned case in FIG. 4B and hence, the advance in phase of the second sound is set off in proportion to the increase of the distance. Therefore, at a position on the head of the occupant H, as illustrated in FIG. 4A, the advance in phase of the second sound becomes smaller than π/4.

As a result, according to the present embodiment, the first sound and the second sound intensify with each other at a position on the head of the occupant H (see the arrow A in FIG. 1 to FIG. 3) thus increasing the sound pressure of the composite tone at a position on the head of the occupant H compared with the above-mentioned case in FIG. 4B. Therefore, according to the present embodiment, even when a sound volume of an entire system is lowered, it is possible to maintain the level of the volume at a position on the head of the occupant H, thereby sound output efficiency can be improved.

In addition, at a position on the foot side of the occupant H (see the arrow C in FIG. 1 to FIG. 3), a distance relative to the speaker 11a is longer compared with the above-mentioned case in FIG. 4B and hence, the delay in phase of the first sound is increased in proportion to the increase of the distance. Therefore, at a position on the foot side of the occupant H, as illustrated in FIG. 4C, the delay in phase of the first sound becomes larger than π/4. Furthermore, at a position on the foot side of the occupant H, a distance relative to the speaker 11b is shorter compared with the above-mentioned case in FIG. 4B and hence, the advance in phase of the second sound is increased in proportion to the decrease of the distance. Therefore, at a position on the foot side of the occupant H, as illustrated in FIG. 4C, the advance in phase of the second sound becomes larger than π/4.

As a result, according to the present embodiment, the first sound and the second sound are canceled each other at a position on the foot side of the occupant H (see the arrow C in FIG. 1 to FIG. 3) thus decreasing the sound pressure of the composite tone at a position on the foot side of the occupant H compared with the above-mentioned case in FIG. 4B. Therefore, according to the present embodiment, it is possible to suppress the deterioration of the sound quality of sounds audible at a position on the head of the occupant H caused by reflection and interference of the sounds output toward the foot side of the occupant H from interior surfaces, the occupant H, or the like in a vehicle, thereby an acoustic environment at a position on the head of the occupant H can be improved.

Here, both the delay in phase of the first sound and the advance in phase of the second sound are set to π/4 based on the following reason. That is, if the phase difference between the first sound and the second sound is excessively increased, components of these sounds that are canceled each other are increased at the time when these sounds are output from the speakers 11a and 11b, thereby the sound output efficiency can be lowered. Accordingly, in the present embodiment, it is preferable that both the delay in phase of the first sound and the advance in phase of the second sound be set to 0 at a position in FIG. 4A at which the most intensified sound pressure is required, and both the delay in phase of the first sound and the advance in phase of the second sound be set to π/2 at a position in FIG. 4C at which the most lowered sound pressure is required. Consequently, in the present embodiment, both the delay in phase of the first sound and the advance in phase of the second sound are set to π/4 that is a value intermediate between 0 and π/2 at a position in FIG. 4B that is a position intermediate between the position in FIG. 4A and the position in FIG. 4C. This configuration can improve an acoustic environment effectively at the position in FIG. 4A.

In addition, in the present embodiment, in order to further improve the acoustic environment at the position on the head of the occupant H, delay of a time corresponding to a path difference between the first sound and the second sound is provided between the output of the first sound and the output of the second sound in a high frequency band (specifically described later) in which interference between the first sound and the second sound is liable to easily occur attributed to a large phase change by a distance difference. The path difference corresponds to a difference in distance from the two speakers 11a and 11b to the position on the head of the occupant H. Accordingly, it is possible to make a time when the first sound arrives at the position on the head of the occupant H and a time when the second sound arrives at the position on the head of the occupant H equal to each other, thereby the acoustic environment at the position on the head of the occupant H can be further improved.

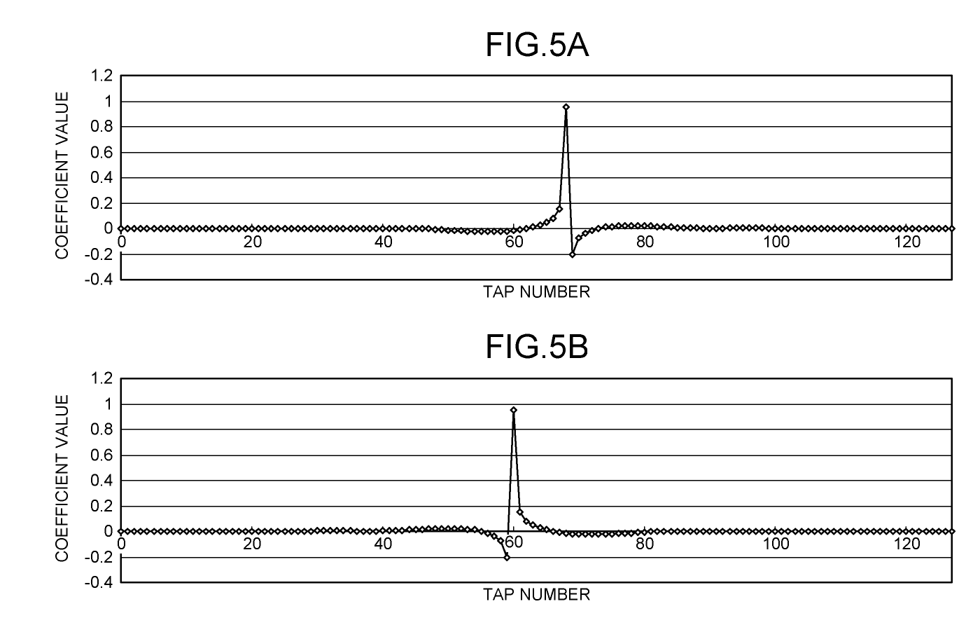

The above-mentioned phase control and time control is achieved by setting filter coefficients as illustrated in FIGS. 5A and 5B to the FIR filters 13a and 13b. FIGS. 5A and 5B are exemplary diagrams illustrating filter coefficients set to the FIR filters 13a and 13b. In examples illustrated in FIGS. 5A and 5B, the filter coefficient is calculated assuming that a sampling frequency is 48 kHz.

FIG. 5A is an exemplary diagram illustrating a filter coefficient designed such that the phase of the first sound is delayed by π/4 with respect to a signal that delays an input signal by an amount of 64 samples and the output of the first sound in a high frequency band is delayed by one-half of a time difference corresponding to the path difference between the first sound and the second sound. The filter coefficient illustrated in FIG. 5A is designed such that the filter coefficient delays the output of the first sound by one-half of a time difference corresponding to a path difference of approximately 50 mm in a high frequency band of 3 kHz or higher. FIG. 5B is an exemplary diagram illustrating a filter coefficient designed such that the phase of the second sound is advanced by π/4 with respect to a signal that delays an input signal by an amount of 64 samples and the delay in output of the second sound in a high frequency band is decreased by one-half of a time difference corresponding to the path difference between the first sound and the second sound. The filter coefficient illustrated in FIG. 5B is designed such that the filter coefficient decreases the delay in output of the second sound by one-half of a time difference corresponding to a path difference of 50 mm at a high frequency band of 3 kHz or higher.

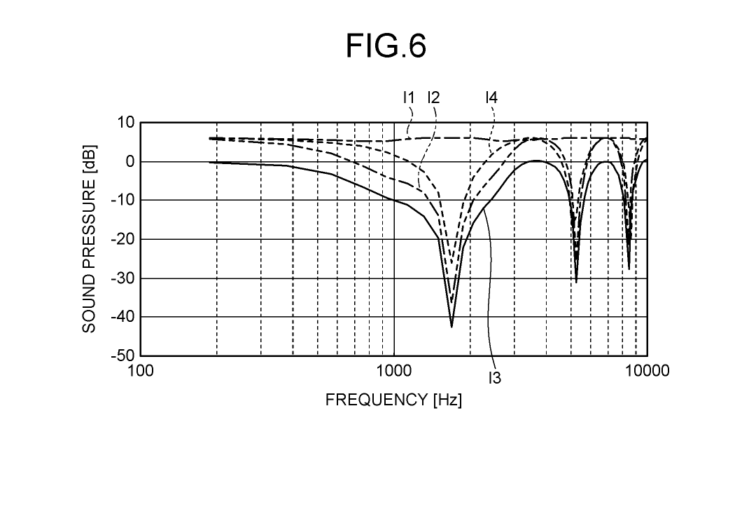

When the above-mentioned filter coefficients illustrated in FIGS. 5A and 5B are used, the sound pressure of a composite tone of the first sound and the second sound is expressed as a graph illustrated in FIG. 6.

A dashed-dotted line 11 in FIG. 6 indicates the sound pressure of the composite tone at a position on the head of the occupant H (see the arrow A in FIG. 1 to FIG. 3). In addition, a chain double-dashed line 12 in FIG. 6 indicates the sound pressure of the composite tone at a position on the foot side of the occupant H (see the arrow C in FIG. 1 to FIG. 3). Furthermore, a solid line 13 in FIG. 6 indicates a sound pressure ratio of a composite tone at a position on the head of the occupant H to a composite tone at a position on the foot side of the occupant H.

A dotted line 14 in FIG. 6 indicates, as a comparative example, the sound pressure of the composite tone at a position on the foot side of the occupant H when a filter coefficient that causes only a delay in time corresponding to the path difference between the first sound and the second sound is used without using the filter coefficient (see FIGS. 5A and 5B) that controls the phases of sounds in the present embodiment. The dotted line 14 is positioned on an upper side (on a high sound pressure side) of the above-mentioned chain double-dashed line 12. It is understood that, according to the present embodiment (chain double-dashed line 12) in which the filter coefficient controls the phases of sounds, the sound pressure of the composite tone at a position on the foot side of the occupant H is decreased compared with the comparative example (dotted line 14) in which the filter coefficient does not control the phases of sounds. That is, according to the present embodiment, as the filter coefficient that controls the phases of sounds is used, the reflections and the interference of sounds at the position on the foot side of the occupant H can be further suppressed, thereby the acoustic environment at the position on the head opposite to the foot side of the occupant H can be further improved.

As explained heretofore, the present embodiment comprises the FIR filter 13a and the FIR filter 13b. The FIR filter 13a delays the phase of the first sound with respect to the phase of an input signal. The first sound is output from the speaker 11a arranged at a position close to the occupant H. The FIR filter 13b advances the phase of the second sound with respect to the phase of an input signal. The second sound is output from the speaker 11b arranged at a position distant from the occupant H. Consequently, it is possible to improve acoustic effects at a position on the head of the occupant H by an easier method without processing of filtering accompanied with complicate calculations in consideration of acoustic characteristics or the like of the speakers 11a and 11b. This advantageous effect requires no headroom margin for filtering thus being effective particularly when the installation space of a sound device is restricted, for example.

### First Modification

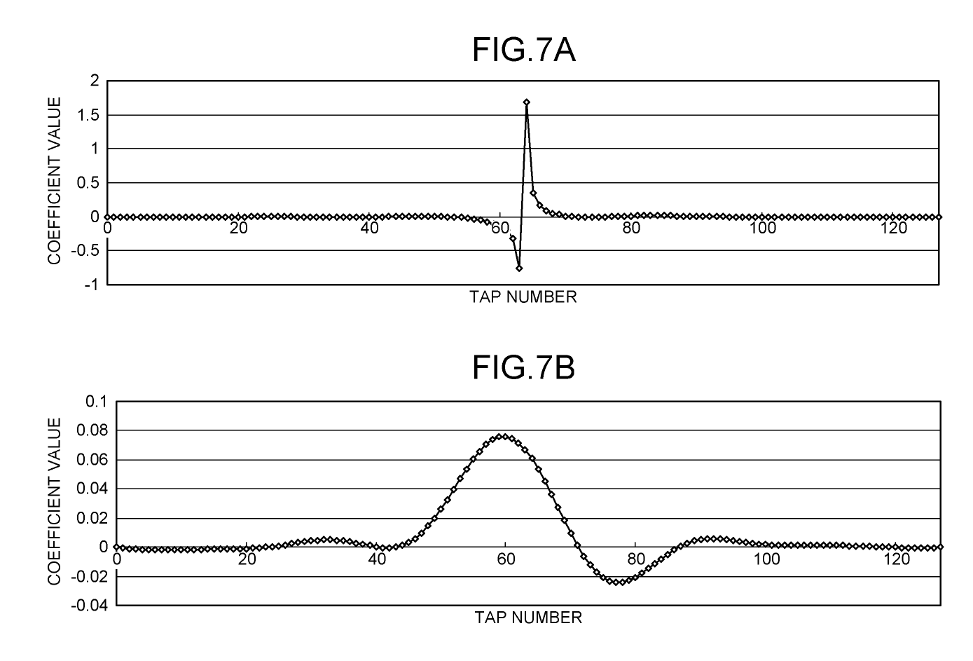

Next, with reference to FIG. 3 and FIGS. 7A and 7B, a first modification is explained. In the first modification, sounds in a high frequency band that are liable to easily interfere with each other are output from only one of the speakers 11a and 11b.

As illustrated in FIG. 3, a speaker device 101 according to the first modification has a substantially same configuration as the case of the speaker device 100 according to the above-mentioned embodiment. The speaker device 101 is one example of an “electronic device”.

In the first modification, one of two FIR filters 23a and 23b filters a high frequency component of one of the first sound and the second sound. According to this configuration, one of the first sound and the second sound is output in a state that the high frequency component thereof is filtered, and the other one of the first sound and the second sound is output in a state that the high frequency component is included therein.

As described above, the phases of the first sound and the second sound are controlled thus acquiring the same effect as the case of giving directivity to sounds from the speakers 11a and 11b so that the sounds advance in the direction toward the head of the occupant H (arrow-A side). However, a variation in phase difference of the first sound and the second sound between the head and the foot side (arrow-C side) of the occupant H depends on the wavelengths of the sounds.

That is, in a low-pitched sound range, a wavelength is long and hence, the path difference between the first sound and the second sound (a distance between the two speakers 11a and 11b) becomes small relative to the wavelength. Therefore, in the low-pitched sound range, the phase difference between the first sound and the second sound becomes small, and a variation in sound pressure between the head and the foot side of the occupant H becomes small. On the other hand, in a high-pitched sound range, a wavelength is short and hence, the path difference between the first sound and the second sound becomes large relative to the wavelength.

Here, as described above, the effect of the phase control is maximized when the phases of the first sound and the second sound are respectively shifted by π/4 to set the phase difference therebetween to π/2. To set the phase difference to π/2 is, in other words, to set the path difference between the first sound and the second sound equal to one-fourth of the wavelength. Accordingly, if the wavelength is shorter than four times of the path difference, the phase is excessively rotated, and it becomes difficult to acquire the effect of the phase control.

The following case is considered; that is, the phases of the first sound and the second sound are respectively shifted by an amount larger than π/2 to set the phase difference therebetween larger than π. To set the phase difference larger than π is to set the path difference shorter than one-half of the wavelength. In this case, the sound pressure of the composite tone on the foot side of the occupant H is larger than the sound pressure of the composite tone on the head of the occupant H and hence, the reflections and interference of the sounds on the foot side of the occupant H become large, and it is impossible to obtain the effect of directivity as in the above-mentioned embodiment.

For this reason, the first modification sets, in a high frequency band corresponding to a wavelength in the vicinity of ¼ to ½ of a path difference, filter coefficients of the FIR filters 23a and 23b so that a sound is output only from the speaker 11a without outputting a sound from the speaker 11b. That is, in the first modification, the filter coefficient of the FIR filter 23b is designed such that the FIR filter 23b also has a function as a low-pass filter. Accordingly, it is possible to suppress the interference of sounds also in a high frequency band. FIGS. 7A and 7B are exemplary diagrams illustrating filter coefficients designed for obtaining such effects.

FIG. 7A is an exemplary diagram illustrating a filter coefficient to be set in the FIR filter 23a. The filter coefficient illustrated in FIG. 7A is designed such that a gain becomes 2 in a high frequency band (a frequency band of 2625 Hz or higher, as one example). Furthermore, FIG. 7B is an exemplary diagram illustrating a filter coefficient to be set in the FIR filter 23b. The filter coefficient illustrated in FIG. 7B is designed such that a gain becomes 0 in a high frequency band.

### Second Modification

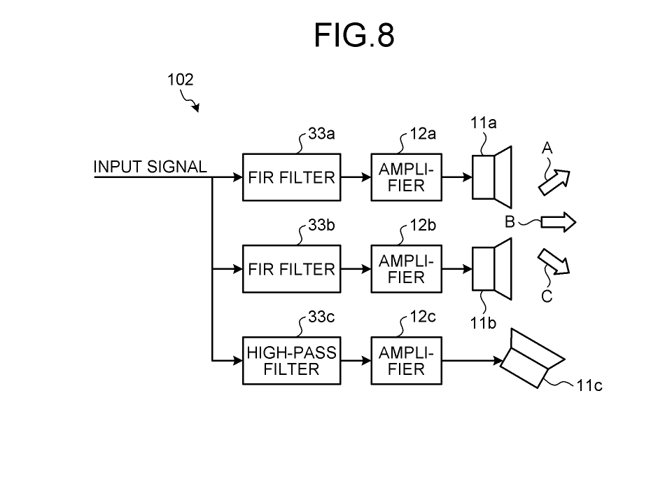

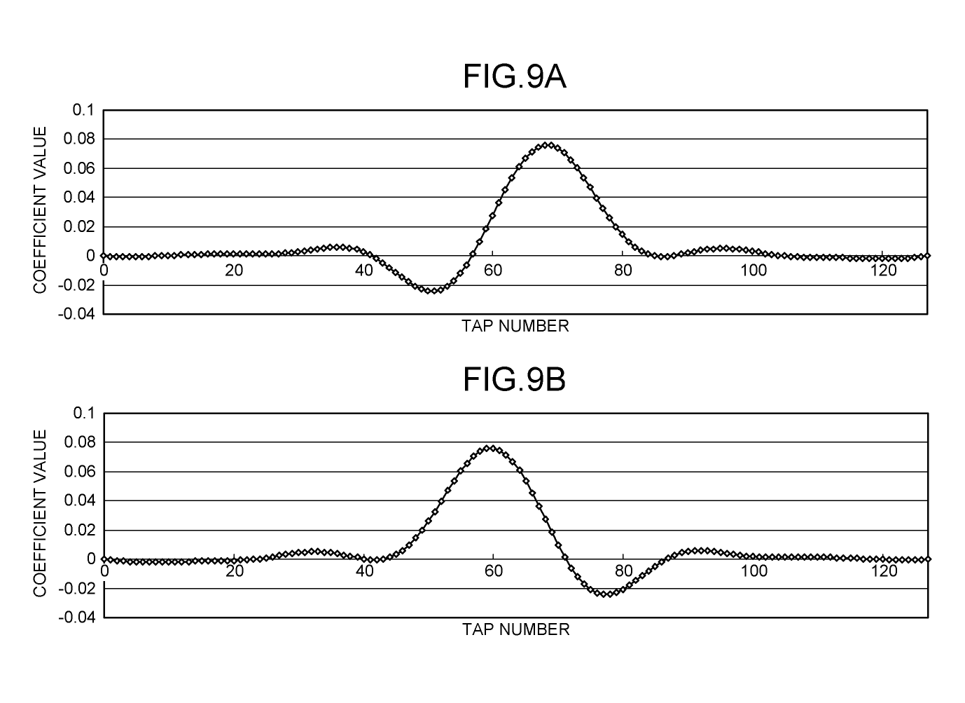

Next, with reference to FIG. 8 and FIGS. 9A and 9B, a second modification is explained. In the second modification, a sound in a high frequency band in which interference is liable to easily occur is output from a member provided separately from the speakers 11a and 11b.

That is, as illustrated in FIG. 8, a speaker device 102 according to the second modification comprises, in contrast to the case of the above-mentioned embodiment, a tweeter 11c provided separately from the speakers 11a and 11b. The speaker device 102 is one example of an “electronic device”. The tweeter 11c is one example of a “third speaker”.

Here, in the second modification, the tweeter 11c is provided so as to mainly output a sound toward the head of the occupant H. That is, the tweeter 11c is arranged so as to face physically in the arrow-A direction.

In addition, in the second modification, the tweeter 11c connects a high-pass filter 33c thereto via an amplifier 12c. Furthermore, each of FIR filters 33a and 33b has a function as a low-pass filter in addition to a function of performing the phase control same as that in the case of the above-mentioned embodiment.

According to this configuration, in the second modification, high frequency components of both the first sound and the second sound are filtered by the FIR filters 33a and 33b, respectively. Furthermore, a high frequency component in an input signal is output from the tweeter 11c that outputs a sound toward the head of the occupant H (see the arrow A) via the high-pass filter 33c. Accordingly, it is possible to output a sound in a high frequency band from the tweeter 11c provided separately from the speakers 11a and 11b toward the head of the occupant H in a state of giving directivity physically to the sound, thereby it is possible to avoid the interference of sounds attributed to the sounds in the high frequency band output from each of the speakers 11a and 11b in a state that the phases of the sounds are shifted each other.

FIGS. 9A and 9B are exemplary diagrams illustrating filter coefficients to be set in the FIR filters 33a and 33b, respectively. The filter coefficient illustrated in FIG. 9A is designed such that the phase of the first sound in a low-pitched sound range is delayed by π/4 with respect to an input signal. The filter coefficient illustrated in FIG. 9B is designed such that the phase of the second sound in a low-pitched sound range is advanced by π/4 with respect to the input signal.

### Third Modification

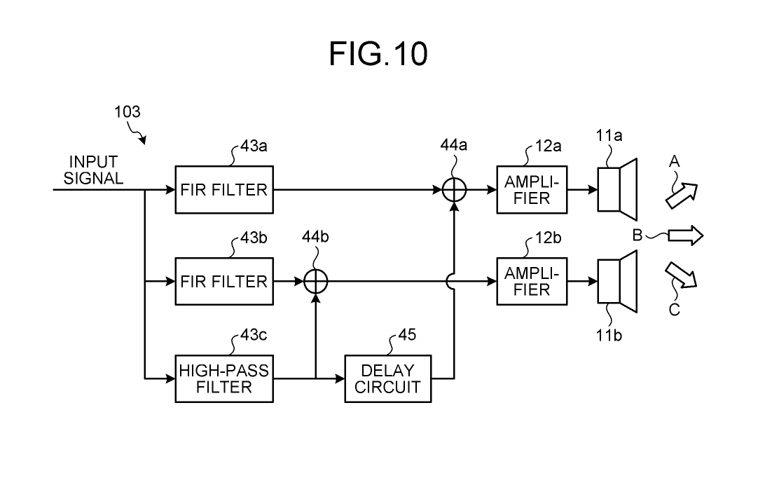

Next, with reference to FIG. 10, a third modification is explained. The third modification is configured such that delay in time corresponding to a path difference between the first sound and the second sound is generated by a physical circuit without relying on a filter coefficient.

As illustrated in FIG. 10, a speaker device 103 according to the third modification comprises the speakers 11a and 11b, the amplifiers 12a and 12b, FIR filters 43a and 43b, a high-pass filter 43c, mixers 44a and 44b, and a delay circuit 45. The speaker device 103 is one example of an “electronic device”.

The mixer 44a is arranged between the amplifier 12a and the FIR filter 43a. The high-pass filter 43c is connected to the mixer 44a via the delay circuit 45. The mixer 44b is arranged between the amplifier 12b and the FIR filter 43b. The high-pass filter 43c is connected to the mixer 44b without passing through the delay circuit 45.

Here, in the third modification also, in the same manner as the case of the above-mentioned second modification, each of the FIR filters 43a and 43b has a function as a low-pass filter in addition to a function that performs the phase control in the same manner as the case of the above-mentioned embodiment. Furthermore, the delay circuit 45 has a function that generates delay in time corresponding to a path difference between the first sound and the second sound.

According to this configuration, in the third modification, the first sound contains a high frequency component delayed by passing through the delay circuit 45. Furthermore, the second sound contains an undelayed, high frequency component. Accordingly, it is possible to easily obtain the same effects as the case of the above-mentioned embodiment without using the filter coefficient incorporating delay in time therein.

In the above-mentioned embodiment (and modifications), the speaker device provided in a vehicle is illustrated as one example of an “electronic device”. However, the technique of the above-mentioned embodiment can be applied to any speaker device other than the speaker device provided in the vehicle. Furthermore, the technique of the above-mentioned embodiment can also be applied to any electronic device other than the speaker device provided that the electronic device is capable of outputting and reproducing sounds.

In addition, in the above-mentioned embodiment, the phases of the first sound and the second sound are shifted by the same amount of phase (π/4) with respect to an input signal, exemplarily. However, in another embodiment, a phase shifted with respect to an input signal may be different between the first sound and the second sound. For example, the phase of the second sound may be advanced by π/2 without shifting the phase of the first sound. However, it is possible for the configuration of the above-mentioned embodiment in which the phases of the first sound and the second sound are shifted by the same amount of phase (π/4) with respect to an input signal to obtain effects more easily since it is unnecessary to perform processing that adjusts the phase of the composite tone of the first sound and the second sound to the phase of the input signal.

In addition, in the other embodiment, the phases of the first sound and the second sound may be shifted by an amount apart from π/4. In this case, the amount of shifting each of the phases of the first sound and the second sound may be determined such that the phase difference of the first sound and the second sound in each frequency band becomes π in a most desired direction to suppress a sound pressure.

Furthermore, in the above-mentioned embodiment, the phases of the first sound and the second sound are set close to each other at a position on the head of an occupant. However, there exists the case that the degree of a phase shift is changed depending on a frequency. In this case, a sound pressure difference attributed to a phase difference may be generated. Accordingly, it is also possible to incorporate correction characteristics for correcting the sound pressure difference into the design of filter coefficients. That is, it is also possible to design the filter coefficients by performing inverse Fourier transform after correcting a decrease in amplitude due to the phase difference in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of reproducing sound from an electronic device comprising:
delaying a first phase of a first sound with respect to a phase of an input signal, the first sound configured to be output from a first speaker of a plurality of speakers arranged adjacent to each other, the first speaker at a first position; and
advancing a second phase of a second sound with respect to the phase of the input signal, the second sound configured to be output from a second speaker out of the plurality speakers, the second speaker at a second position,
wherein a distance between the first position and a user is smaller than a distance between the second position and a user.

2. The method of claim 1, further comprising providing a phase difference between the first phase and the second phase in a high frequency band, the phase difference corresponding to a path difference between the first sound and the second sound.

3. The method of claim 1, wherein
the delaying comprises delaying the first phase by a third phase, and
the advancing comprises advancing the second phase by the third phase.

4. The method of claim 3, wherein the third phase is π/4.

5. The method of claim 1, further comprising filtering a high frequency component of one of the first sound and the second sound.

6. The method of claim 1, further comprising:
filtering high frequency components of both the first sound and the second sound; and
outputting a high frequency component of the input signal from a third speaker of the plurality of speakers, the third speaker configured to output a sound mainly toward a head of the user.

7. The method of claim 1, further comprising:
filtering a high frequency component of the first sound; and
outputting a high frequency component of the input signal from the first speaker together with the first sound in a state in which the high frequency component of the input signal is delayed by an amount of time corresponding to a path difference between the first sound and the second sound.

8. An electronic device comprising:
a plurality of speakers arranged adjacent to each other; and
a filter configured to delay a first phase of a first sound with respect to a phase of an input signal and to advance a second phase of a second sound with respect to the phase of the input signal, the first sound configured to be output from a first speaker of the plurality speakers, the first speaker at a first position, the second sound configured to be output from a second speaker of the plurality speakers, the second speaker at a second position,
wherein a distance between the first position and a user is smaller than a distance between the second position and a user.

9. The electronic device of claim 8, wherein the filter is further configured to provide a phase difference between the first phase and the second phase in a high frequency band, the phase difference corresponding to a path difference between the first sound and the second sound.

10. The electronic device of claim 8, wherein the filter is configured to delay the first phase by a third phase and to advance the second phase by the third phase.

11. The electronic device of claim 10, wherein the third phase is π/4.

12. The electronic device of claim 8, wherein the filter is further configured to filter a high frequency component of one of the first sound and the second sound.

13. The electronic device of claim 8, wherein
the speakers further comprise a third speaker configured to output a sound mainly toward a head of the user, and
the filter is further configured to filter high frequency components of both the first sound and the second sound, and to output a high frequency component of the input signal from the third speaker.

14. The electronic device of claim 8, wherein the filter is further configured to filter a high frequency component of the first sound, and to output a high frequency component of the input signal from the first speaker together with the first sound in a state in which the high frequency component of the input signal is delayed by an amount of time corresponding to a path difference between the first sound and the second sound.
